(19) United States
(12) Patent Application Publication
(10) Pub. No.: US 2014/0250399 A1
(43) Pub. Date: Sep. 4, 2014

(54) Scheduling Systems

(71) Applicant: Emerson Electric Co., St. Louis, MO (US)

(72) Inventor: Shilpa Kiransing Gaherwar, Pune (IN)

(73) Assignee: Emerson Electric Co., St. Louis, MO (US)

(21) Appl. No.: 14/194,298

(22) Filed: Feb. 28, 2014

(30) Foreign Application Priority Data
Mar. 4, 2013 (IN) 650/MUM/2013

(51) Int. Cl. G06F 3/0484; G06F 3/0485; G06F 3/0488; G06F 3/0482

(52) U.S. Cl. CPC G06F 3/04842; G06F 3/0482; G06F 3/0485; G06F 3/0488
USPC 715/771

(57) ABSTRACT

An exemplary embodiment includes a scheduling system for scheduling operation of a device. The scheduling system generally includes a touch screen based user interface, a selection module, a storage memory, and a communication network. The touch screen based user interface displays a plurality of scrollable, selectable options corresponding to different settings, different modes of operation of the device to be scheduled, and different time zones for which the system is to be scheduled. The touch screen based user interface further displays the different settings and the different modes of operation of the device for the different time zones as selected by a user to define a particular operation schedule for the device. The selection module facilitates navigation and selection of the options from the plurality of scrollable, selectable options displayed on the touch screen based user interface for selectively defining a particular operation schedule for the device.

### CROSS-REFERENCE TO RELATED APPLICATION

This application claims the benefit and priority of Indian Patent Application No. 650/MUM/2013 filed Mar. 4, 2013. The entire disclosure of the above application is incorporated herein by reference.

### FIELD

The present disclosure relates to scheduling systems configurable on hand-held communication devices for scheduling operations of devices having different operational settings and operable in different modes.

### BACKGROUND

This section provides background information related to the present disclosure which is not necessarily prior art.

A large number of devices/systems such as heating and cooling systems and heating, ventilation, and air conditioning (HVAC) systems, for example, air conditioners and refrigeration systems operate with different operational settings and are operable in different modes. For example, an air conditioner has different temperature and humidity settings that may be varied during the day as per requirements. During the day time, the air conditioner operates at a different temperature than it does during the evening or night. Generally, the control system for the air conditioner uses a thermostat for selectively changing the temperature settings. The thermostat senses the ambient temperature, and accordingly, changes a setting of the air conditioner for maintaining a temperature near a desired set-point, thereby selectively varying the temperature conditions. The thermostat does this by switching heating or cooling devices on or off and/or by regulating the flow of a heat transfer fluid as needed to maintain the correct temperature.

The thermostat may use a variety of sensors to measure the temperature. The output of the sensor then controls the heating or cooling devices of the air conditioner. The thermostat may switch on and off at temperatures on either side of the set-point, the difference between the point of switching on and off of the thermostat and the set-point of the thermostat is known as hysteresis and prevents excessive switching of the controlled equipment.

The thermostat is programmed for scheduling the operation of the air conditioner. The thermostat is generally manually operated or programmable using a conventional user interface. But the conventional user interface fails to precisely program the thermostat such that precise scheduling of the air conditioner by the thermostat becomes difficult. Further, the thermostat may be programmed based on predetermined heating or cooling schedules only, and the conventional user interface lacks flexibility to customize the heating or cooling schedules and precisely set the heating or cooling schedules. The predetermined heating schedules may include a heating schedule for an entire week, a heating schedule for Monday to Friday, a heating schedule for Saturday and Sunday, or a different heating schedule for each day of the week. Similarly, the predetermined cooling schedules may include a cooling schedule for an entire week, a cooling schedule for Monday to Friday, a cooling schedule for Saturday and Sunday, or a different cooling schedule for each day of the week.

The conventional user interface for most thermostats include a plurality of rigid keys or tabs for setting the desired temperature for different time period slots as per the predetermined heating or cooling schedules. With such a configuration of the user interface, the user needs to navigate a total of 4-5 screens under different subtitles options and is required to perform a number of rigid key press actions for incrementing and decrementing the values and navigating between different tabs. Accordingly, the user may find the action of programming the thermostat time consuming and inconvenient. Still further, the conventional user interfaces used in thermostats are complex to operate, thereby making the programming of the thermostat inconvenient. Furthermore, the conventional user-interface for programming a thermostat in accordance with a predetermined heating or cooling schedule requires multiple inputs from the user as well as constant user attention. The conventional user interface for programming a thermostat requires a trained user for programming the thermostat.

Furthermore, most thermostats may be programmable in accordance with the predetermined heating or cooling schedules only, and the user is left with no options for customizing the heating or cooling settings of the air conditioner as per his/her personal requirement. Still further, most thermostats using conventional user interfaces fail to precisely set the heating or cooling schedules.

Accordingly, there is a need for a scheduling system that has a user friendly user-interface for conveniently, quickly, and reliably programming the thermostat of a system. Further, there is need for a scheduling system that precisely sets the heating or cooling schedules. Furthermore, there is a need for a scheduling system that may be configured on a hand-held device, wherein the primary purpose of the hand-held device is different from programming the thermostat, thereby eliminating the need for a dedicated programming device for programming the thermostat. Moreover, there is a need for a scheduling system for programming the thermostat that is simple to operate and that requires less user effort, less user attention, and less user skill for programming the thermostat. Additionally, there is a need for a scheduling system that has fewer moving parts and accordingly is less prone to failure and requires less maintenance. Also, there is a need for a scheduling system that enables the user to define and set heating or cooling schedules at will and as per his/her personal requirement and that are easily customizable.

### SUMMARY

This section provides a general summary of the disclosure, and is not a comprehensive disclosure of its full scope or all of its features.

According to aspects of the present disclosure, exemplary embodiments are disclosed of scheduling systems. An exemplary embodiment includes a scheduling system for scheduling operation of a device. The scheduling system generally includes a touch screen based user interface, a selection module, a storage memory, and a communication network. The touch screen based user interface displays a plurality of scrollable, selectable options corresponding to different settings, different modes of operation of the device to be scheduled, and different time zones for which the system is to be scheduled. The touch screen based user interface further displays the different settings and the different modes of operation of the device for the different time zones as selected by a user to define a particular operation schedule for the device. The selection module facilitates navigation and selection of the options from the plurality of scrollable, selectable options displayed on the touch screen based user interface for selectively defining a particular operation schedule for the device. The storage memory stores data corresponding to different settings, different modes of operation of the device to be scheduled, and different time zones for which the device is to be scheduled. The communication network facilitates communication of different settings and modes of operation of the device corresponding to different time zones in accordance with a particular operation schedule for controlling the device as per a defined operation schedule set by the user for the device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a schematic representation of a user interface for a scheduling system configurable on a smart phone in accordance with an embodiment of the present disclosure, wherein the user interface displays various options and facilitates selection of options for scheduling operations of a device having different settings and operable in different modes;

FIG. 2 illustrates a schematic representation of the user interface of the smart phone of FIG. 1, with a first set of selections made for defining an operational schedule for scheduling a thermostat for Monday morning;

FIG. 3 illustrates a schematic representation of the user interface of the smart phone of FIG. 1, with another set of selections made for defining an operational schedule for scheduling a thermostat for Friday evening;

FIG. 4 illustrates a schematic representation of a user interface for a scheduling system configurable on a smart phone in accordance with an another embodiment of the present disclosure, wherein the user interface displays various options and facilitates selection of options for scheduling operations of a device having different settings and operable in different modes, and wherein the user interface also includes an extra or “advanced settings” button or tab; and

FIG. 5 illustrates a schematic representation of the smart phone in FIG. 4 after the advanced settings button or tab (FIG. 4) has been selected such that a second screen is displayed that includes various options for scheduling operations of a device having different settings and operable in different modes.

### DETAILED DESCRIPTION

Example embodiments will now be described more fully with reference to the accompanying drawings.

The thermostat of a control system of a device/system (e.g., an air conditioner/refrigeration system, etc.) is programmed for scheduling the operation of the device, such as the air conditioner. The thermostat may be used for scheduling the operation of other devices/systems having different operational settings and operable in different modes. The thermostat is generally manually operated or programmable using a conventional user interface. But the conventional user interface fails to precisely program the thermostat and precise scheduling of the air conditioner by the thermostat becomes difficult. Further, the thermostat may be programmed based on predetermined heating or cooling schedules only and the conventional user interface lacks flexibility to customize the heating or cooling schedules and precisely set the heating or cooling schedules. The predetermined heating schedules may include a heating schedule for an entire week, a heating schedule for Monday to Friday, a heating schedule for Saturday and Sunday, or a different heating schedule for each day of the week. Similarly, the predetermined cooling schedules may include a cooling schedule for an entire week, a cooling schedule for Monday to Friday, a cooling schedule for Saturday and Sunday, or a different cooling schedule for each day of the week.

The conventional user interface for most thermostats include a plurality of rigid keys or tabs for setting the desired temperature for different time period slots as per the predetermined heating or cooling schedules. With such a configuration of the user interface the user needs to navigate a total of 4-5 screens under different subtitles options and is required to perform a number of rigid key press actions for incrementing and decrementing the values and navigating between different tabs for setting the heating or cooling schedule, accordingly, the user may find the action of programming the thermostat time consuming and inconvenient. Still further, the conventional user interface used in thermostats is complex to operate, thereby making the programming of thermostats inconvenient. Furthermore, the conventional user-interface for programming thermostats in accordance with the predetermined heating or cooling schedules require multiple inputs from the user as well as constant user attention. The conventional user interface for programming the thermostats requires a trained user for programming the conventional thermostat.

Furthermore, most thermostats may be programmable in accordance with the predetermined heating or cooling schedules only, and the user is left with no options for customizing the heating or cooling settings of the air-conditioner as per his/her personal requirement. Still further, most thermostats using a conventional user interface fail to precisely set the heating or cooling schedules.

The present disclosure envisages a scheduling system that will ameliorate one or more problems of the prior art. In exemplary embodiments disclosed herein, a scheduling system may be configurable on a hand-held device (e.g., a mobile phone, etc.) for scheduling operation of a device/system such as an air conditioner or a refrigeration system. The scheduling system may be used for scheduling operation of a refrigeration system, air conditioner, or any other similar device/system that requires frequent regulation. The scheduling system may be used for programming a thermostat, which, in turn, controls the operation of the air conditioner based on user defined and customizable heating or cooling schedules. In accordance with another embodiment, the scheduling system may also be used for programming an electric motor, compressors, thermostats, valves, regulators, and gearbox.

In an exemplary embodiment, there is a scheduling system for scheduling operation of a device. In this example, the scheduling system generally includes a touch screen based user interface, a selection module, a storage memory, and a communication network. The touch screen based user interface displays a plurality of scrollable, selectable options corresponding to different settings, different modes of operation of the device to be scheduled, and different time zones for which the system is to be scheduled. The touch screen based user interface further displays the different settings and the different modes of operation of the device for the different time zones as selected by a user to define a particular operation schedule for the device. The selection module facilitates navigation and selection of the options from the plurality of scrollable, selectable options displayed on the touch screen based user interface for selectively defining a particular operation schedule for the device. The storage memory stores data corresponding to different settings, different modes of operation of the device to be scheduled, and different time zones for which the device is to be scheduled. The communication network facilitates communication of different settings and modes of operation of the device corresponding to different time zones in accordance with a particular operation schedule for controlling the device as per a defined operation schedule set by the user for the device.

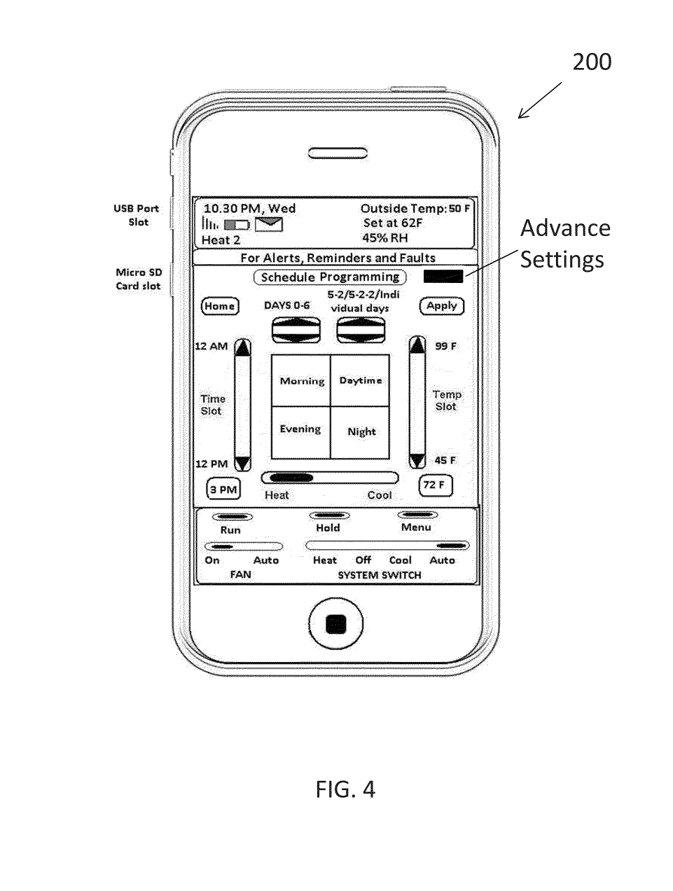

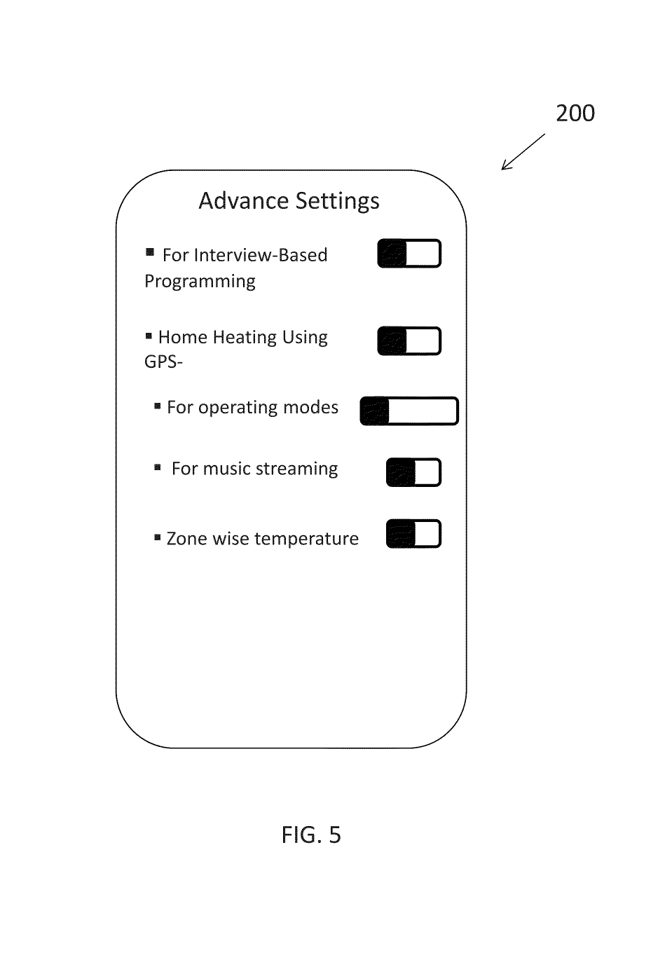

The touch screen based user interface may be a touch screen of a mobile phone. Generally, the touch screen based user interface displays a plurality of scrollable, selectable options on a single screen corresponding to different settings, different modes of operation of the device to be scheduled, and different time zones for which the device is to be scheduled. Alternatively, the touch screen based user interface may be a touch screen of a remote control for remotely controlling the device. In yet another embodiment, the touch screen based user interface may be a touch screen of a Tablet device. Also, the touch screen based user interface may include more than one screen in alternative embodiments (e.g., FIGS. 4 and 5, etc.).

Generally, the plurality of scrollable, selectable options displayed on the touch screen based user interface are navigated and selected by the touch of the user. Typically, at least one of the plurality of scrollable, selectable options displayed on the touch screen based user interface facilitates navigation through different time zones and selection of a time zone for which the device is to be scheduled.

Preferably, at least one of the plurality of scrollable, selectable options displayed on the touch screen based user interface facilitates navigating through different temperature settings and selecting a temperature setting for achieving temperature control corresponding to a particular operation schedule defined by the user for the device. Additionally, or alternatively, at least one of the plurality of scrollable, selectable options displayed on the touch screen based user interface facilitates navigating through different humidity settings and selecting a humidity setting for achieving humidity control corresponding to a particular operation schedule defined by the user of the device.

Typically, the touch screen based user interface may further displays a save option for facilitating saving of the settings and modes of operation of the device corresponding to a particular operation schedule set by the user for future use. The touch screen based user interface may also further display additional information such as information regarding time, day, temperature and humidity conditions.

In accordance with an embodiment of the present disclosure, the touch screen based user interface may display alert messages in case of any fault in the device.

The communication network facilitates communication of different settings, modes of operation of the device corresponding to different time zones in accordance with the particular operation schedule set by the user to a thermostat of a control system of the device.

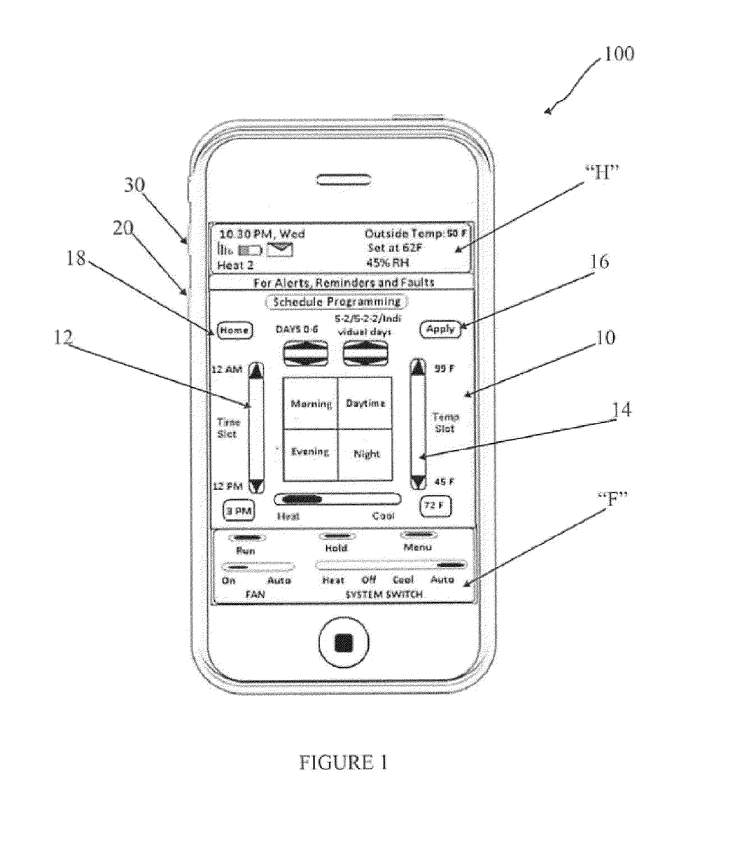

With reference to the figures, FIG. 1 illustrates a user interface for a scheduling system configurable on a smart phone 100, wherein the user interface displays various options and facilitates selection of options for scheduling operations of a device having different settings and operable in different modes. The various options required for scheduling a device are displayed on a single screen of the smart phone, thereby facilitating convenient programming of the device. Accordingly, the user does not have to navigate through different screens for making selections for scheduling operations of the device in this exemplary embodiment. The scheduling system makes the operation of scheduling quick, convenient, and enjoyable. The present disclosure explains the operation of an exemplary embodiment of a scheduling system by referring to an example of a smart phone configured with the scheduling system. But the scheduling system in accordance with the present disclosure can be configured on any other device having a touch screen based user interface, such as a tablet device, a laptop computer, etc. Although the scheduling systems of the present disclosure are used for scheduling operation of a thermostat of a control system of an air conditioner having different settings and operable in different modes, a scheduling system of the present disclosure may be used for scheduling operations of other similar devices. Also, the user interface may include more than one screen in alternative embodiments (e.g., FIGS. 4 and 5, etc.).

As shown in FIG. 1, the mobile phone 100 has a touch screen based user interface. The mobile phone 100 may be connected to the internet for uploading an application module for the scheduling system, thereby facilitating the use of the scheduling system on the mobile phone 100. The touch screen of the mobile phone 100 displays various options and facilitates selection of options for programming the thermostat. In accordance with another embodiment, the application module for the scheduling system can be installed on a device that would not be connected to a server or that is not linked to the Internet. In this alternative embodiment, a USB reader or a SD card reader configured on the device or mobile phone that is not connected to the server may be used for uploading an application module for the scheduling system, and accordingly, the mobile phone 100 could still be used to program a thermostat. As illustrated in FIGS. 1, 2, and 3 3, the mobile phone 100 has a Universal Serial Bus (USB) port slot 30 and a Micro SD card slot 20 configured thereon. Further, such a configuration enables a user to save particular schedules that have been programmed by the user in a USB or a Micro SD card for future use.

The display area of the touch screen may be divided into a header area “H”, a footer area “F”, and a programming screen area 10. The header area “H” displays time, date, battery status, Short Message Service (SMS) status, and signal strength status as is displayed on the screen of a conventional mobile phone. The footer area “F” displays fan and system switch position. The header and the footer may be used for displaying any other auxiliary information required and is not limited to display of time, date, battery status, SMS status, and signal strength status as illustrated in FIGS. 1, 2, and 3.

The programming screen area 10 displays the plurality of scrollable, selectable options corresponding to different settings, different modes of operation of the air conditioning system to be scheduled, and different time zones for which the air conditioning system is to be scheduled. Such scrollable, selectable options facilitate setting of a user defined operation schedule by the user. The programming screen area 10 of the touch screen may display options for changing the scheduling format to be applied on the air conditioner, particularly, the programming screen area displays the Heating and Cooling schedule selection slider 11 for selecting the scheduling format (heat or cool) to be applied on the air conditioner. The scheduling format applied on the air conditioner may be a 5-2 format in which the air conditioner operates in accordance with a particular operation schedule for 5 days, particularly, the 5 working days of the week and operates in accordance with another operation schedule for rest of the week. In accordance with another embodiment, the scheduling format applied on the air conditioner may be a 5-1-1 format in which the air conditioner operates in accordance with a particular operation schedule for 5 days, particularly, for the 5 working days of the week, operates in accordance with another operation schedule for 1 day, i.e. Saturday, and operates in accordance with still another operation schedule for the last day of the week, i.e. Sunday. The scheduling format applied on the air conditioner may be a 6-0 format in which the air conditioner operates in accordance with a particular operation schedule for 6 days and remains OFF on the last day i.e., on Sunday. The operation schedule applicable for a particular day is defined and set by the user using the other options displayed at the programming screen area 10 of the touch screen. The programming screen area 10 of the touch screen displays a time slot scroll 12 for scrolling through different time zones (e.g., morning, daytime, evening, night) to facilitate navigation through different time zones and selection of a time zone for which the system is to be scheduled. The programming screen area 10 of the touch screen also displays a temperature slot scroll 14 for scrolling through different temperature settings to facilitate navigation through different temperature settings and selection of a temperature setting for achieving temperature control corresponding to a particular operation schedule defined by the user of the air conditioner.

The footer area “F” of the touch screen displays operation modes of different auxiliary equipment of the air conditioner such as fan ON mode and fan OFF mode. In accordance with an embodiment, the touch screen also displays a humidity slot scroll (not illustrated in FIG. 1) for scrolling through different humidity settings to facilitate navigation through different humidity settings and selection of a humidity setting for achieving humidity control corresponding to a particular operation schedule defined by the user of the air conditioning system. The touch screen also displays a save option for facilitating saving of the settings and modes of operation of the air conditioning system corresponding to a particular operation schedule set by the user for future use, such save option is displayed at the programming screen area 10. The different options displayed on the programming screen area 10 of the touch screen such as the time slot scroll 12 and the temperature slot scroll 14 are scrollable and selectable by a touch of the user. Such a configuration facilitates quick, convenient and precise navigation and selection of the options from the plurality of scrollable, selectable options by a user for selectively and precisely defining a particular operation schedule for the air conditioner. The programming screen area 10 of the touch screen displays all the options required for defining a particular operation schedule for the air conditioner on one screen, thereby preventing the need for navigating different screens for selecting different parameters for setting particular operation schedules for the air conditioner. In accordance with an embodiment, the programming screen area 10 of the touch screen also displays an enter tab 16 and a home tab 18. The enter tab 16 is used once the user has finalized defining a particular operation schedule and for setting the particular operation schedule. The programming screen area 10 of the touch screen displays different settings, different modes of operation of the air conditioner for the different time zones corresponding to the particular operation schedule of the air conditioner defined by the user on a single screen. The display of the touch screen and the various options displayed on the touch screen such as the time slot scroll 12 and temperature slot scroll 14 may be varied as required. For example, the units used in the temperature slot scroll 14 may be varied and set by the user as per convenience.

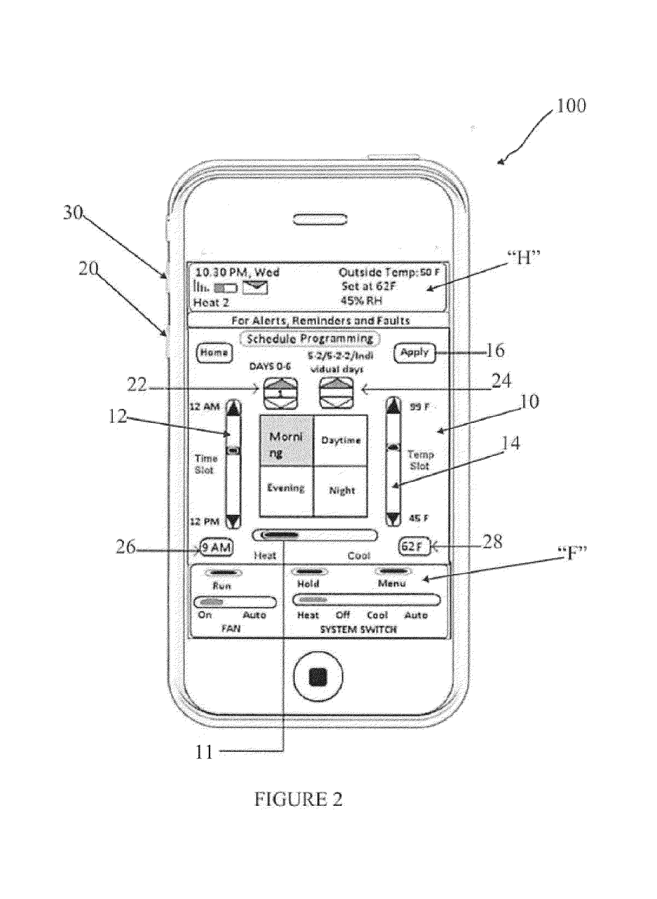

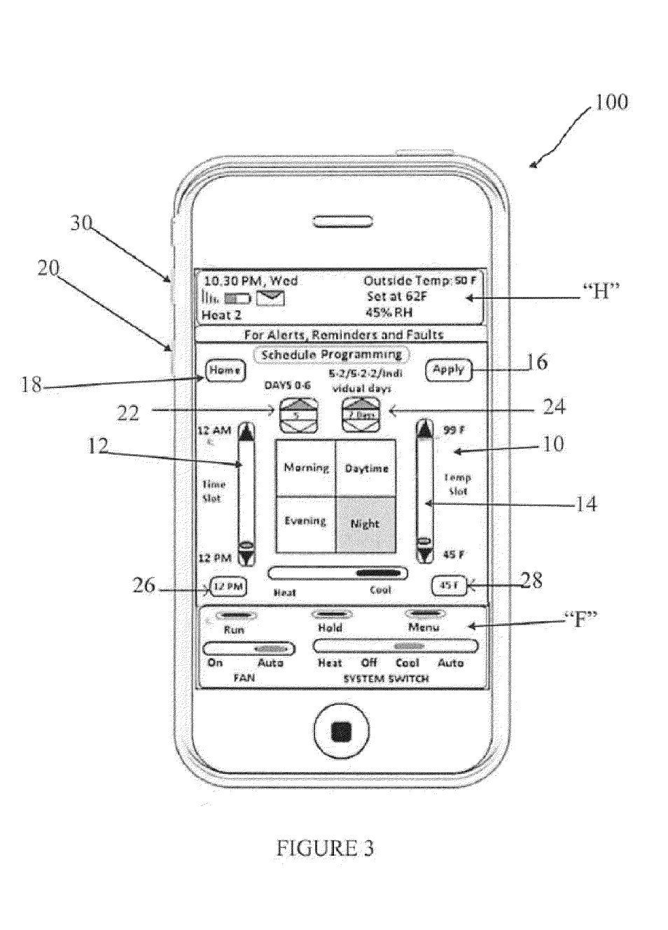

The various options displayed on the programming screen area 10 of the touch screen are navigated and selected to define the operation schedule for the air conditioner, for example, for a particular day and time such as for Monday morning. FIG. 2 illustrates a schematic representation of the touch screen, wherein the various options such as the time slot scroll 12, temperature slot scroll 14, the day selection scroll 22, and scheduling format selection scroll 24 are displayed on the programming screen area 10 of the touch screen and are selected or set for setting the temperature and fan status for defining an operation schedule of the thermostat for a Monday morning, the day selection scroll 22 is indicating 1, i.e., Monday. The temperature selected and the time selected is displayed on a selected temperature display zone 28 and a selected time display zone 26. The air conditioner will operate in accordance with the schedule set and illustrated in FIG. 2. Similarly, FIG. 3 illustrates a schematic representation of the touch screen, wherein the various options displayed on the programming screen area 10 of the touch screen are selected for setting the temperature and fan status for defining a schedule for a Friday evening, the day selection scroll 22 is indicating 5, i.e., Friday. The air conditioner will operate in accordance with the schedule set and illustrated in FIG. 3. The selected temperature display zone 28 and the selected time display zone 26 display temperature and time selected corresponding to schedule defined for Friday evening.

FIG. 4 illustrates a schematic representation of a user interface for a scheduling system configurable on a smart phone 200 in accordance with another exemplary embodiment of the present disclosure. In this example, the smart phone 200 includes a touch screen based user interface having features identical to the features of the touch screen user interface shown in FIGS. 1 through 3 and described above. Accordingly, the above description of the touch screen user interface of smart phone 100 (FIGS. 1 through 3) is also applicable to common features of the touch screen user interface of smart phone 200 (FIGS. 4 and 5). For example, the touch screen user interface of smart phone 200 includes a programming screen area, time slot scroll, temperature slot scroll, enter tab, home tab, Micro car SD slot, day selection scroll, format selection scroll, selected time display zone, selected temperature display zone, USB port slot, identical to or similar to the corresponding features shown in FIGS. 1 through 3 and described above.

In this exemplary embodiment, there is an extra or “advanced setting” button or tab. When the user selects or clicks on the advanced settings button or tab, a second screen is displayed as shown in FIG. 5. The second screen includes additional options or advanced settings including For Interview-Based Programming (e.g., asks you questions and then programs itself based on your answers, etc.), For Home Heating Using GPS-Based Arrival Prediction, For operating modes, For music streaming feature, and Zone wise temperature.

For Interview-Based Programming, it may ask the user questions and then programs itself based on the user's answers. For Home Heating Using GPS-Based Arrival Prediction, a thermostat uses GPS and an iOS or Android app to know when the user has left the house so it can automatically adjust the temperature. It also knows when the user is returning home so it can make the house comfortable for the user upon arrival. For operating modes, software may simulate the functionality of manual, programmable, and GPS controlled tree operating mode. The music streaming feature may also include audible alarm. The zone wise temperature and display enable may allow room by room control. Alternative embodiments may include additional or different options, such as real-time energy use tracking, energy usage info, customize your thermostat, and data/SD card backup.

The touch screen may also display alert messages in case of any fault in the system. The touch screen may also display reminder messages for reminding the user to perform regular maintenance of the air conditioning system. Although the scheduling system is explained with regard to the air conditioner, the scheduling system may also be used for other devices or systems, such as refrigeration systems, etc.

The touch screen of the scheduling system in accordance with the present disclosure is easy to read and operate. The touch screen facilitates typing and swiping for programming the thermostat. More specifically, such a configuration allows the user to simply slide a finger from tab to tab and only raise it in-between for making selections and programming the thermostat to define the operation schedule for the air conditioning system. Such a configuration allows the user to drag and drop various widgets, images, and icons to personalize the display and configure a customized start-up screen for schedules.

The scheduling system includes a storage memory to store data corresponding to different settings, different modes of operation of the device to be scheduled, and different time zones for which the device is to be scheduled. In case the scheduling system is configured on a hand-held communication device such as a mobile phone, the storage memory of the mobile phone may be used for storing data corresponding to different settings, different modes of operation of the device to be scheduled, and different time zones for which the device is to be scheduled. The scheduling system utilizes a communication network to facilitate communication of different settings, modes of operation of the device corresponding to different time zones in accordance with a particular operation schedule to the device for controlling the device as per defined operation schedule set by the user for the device. The present disclosure is not limited to any particular communication network used for communicating the different settings, modes of operation of the device corresponding to different time zones in accordance with a particular operation schedule to the device.

Exemplary embodiments disclosed herein of a scheduling system for scheduling operations of a device may provide one or more (but not necessarily any or all) of the following advantages. For example, exemplary embodiments may provide a scheduling system configurable on a smart phone, wherein various options required for scheduling a device are displayed on a single screen of the smart phone, thereby facilitating convenience in programming of the device. Additional options or advanced settings may be displayed on a second screen in some embodiments. Exemplary embodiments may provide a scheduling system configurable on a hand-held device such as a mobile phone or a remote control. Exemplary embodiments may provide a scheduling system that enables a user to define heating or cooling schedules of a device at will, and the heating or cooling schedules are easily customizable by the scheduling system. Exemplary embodiments may provide a scheduling system that precisely sets the heating or cooling schedules of a device and/or that makes programming a thermostat of a control system of a device convenient, quick, and/or reliable. Exemplary embodiments may provide a scheduling system that is configured on a hand-held device, wherein the primary purpose of the hand-held device is different from programming a thermostat of a system, thereby eliminating the need for a dedicated programming device for programming the thermostat. Exemplary embodiments may provide a scheduling system for programming a thermostat of a system that requires less effort and is simple to operate. Exemplary embodiments may provide a scheduling system that has fewer number of moving parts and accordingly is less prone to failure. Exemplary embodiments may provide a scheduling system for programming a thermostat of a system that requires less maintenance. Exemplary embodiments may provide a scheduling system that may be conveniently retrofitted on any system or device for scheduling operation of the system or device. Exemplary embodiments may provide a scheduling system that ameliorates one or more problems of the prior art and/or that at least provides a useful alternative.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. For example, the numerical values mentioned for the various physical parameters, dimensions, or quantities may only be approximations, and it is envisaged that the values higher/lower than the numerical values assigned to the parameters, dimensions, or quantities may fall within the scope of the disclosure, unless there is a statement in the specification specific to the contrary. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The use of the expression “at least” or “at least one” suggests the use of one or more elements or features, as the use may be in the embodiment of the disclosure to achieve one or more of the desired results.

The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Any discussion of documents, acts, materials, devices, articles or the like that has been included in this specification is solely for the purpose of providing context for the disclosure. It is not to be taken as an admission that any or all of these matters form part of the prior art base or were common general knowledge in the field relevant to the disclosure as it existed anywhere before the priority date of this application.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A scheduling system for scheduling operation of a device, the scheduling system comprising:
a touch screen based user interface adapted to display a plurality of scrollable, selectable options corresponding to different settings, different modes of operation of the device to be scheduled, and different time zones for which the device is to be scheduled, the touch screen based user interface further adapted to display the different settings and the different modes of operation of the device for the different time zones as selected by a user to define a particular operation schedule for the device;
a selection module adapted to facilitate navigation and selection of the options from the plurality of scrollable, selectable options displayed on the touch screen based user interface for selectively defining a particular operation schedule for the device;
a storage memory adapted to store data corresponding to different settings, different modes of operation of the device to be scheduled and different time zones for which the device is to be scheduled; and
a communication network adapted to facilitate communication of different settings, modes of operation of the device corresponding to different time zones in accordance with a particular operation schedule to the device for controlling the device as per a defined operation schedule set by the user for the device.

2. The scheduling system of claim 1, wherein the touch screen based user interface is adapted to display on a single screen a plurality of scrollable, selectable options corresponding to different settings, different modes of operation of the device to be scheduled and different time zones for which the device is to be scheduled.

3. The scheduling system of claim 1, wherein the plurality of scrollable, selectable options displayed on the touch screen based user interface are navigated and selected by the user's touch.

4. The scheduling system of claim 1, wherein at least one of the plurality of scrollable, selectable options displayed on the touch screen based user interface facilitates navigation through different time zones and selection of a time zone for which the device is to be scheduled.

5. The scheduling system of claim 1, wherein at least one of the plurality of scrollable, selectable options displayed on the touch screen based user interface facilitates navigating through different temperature settings and selecting a temperature setting for achieving temperature control corresponding to a particular operation schedule defined by the user of the device.

6. The scheduling system of claim 1, wherein at least one of the plurality of scrollable, selectable options displayed on the touch screen based user interface facilitates navigating through different humidity settings and selecting a humidity setting for achieving humidity control corresponding to a particular operation schedule defined by the user of the device.

7. The scheduling system of claim 1, wherein the touch screen based user interface further displays a save option for facilitating saving of the settings and modes of operation of the device corresponding to a particular operation schedule set by the user for future use.

8. The scheduling system of claim 1, wherein the touch screen based user interface further displays additional information regarding one or more of time, day, temperature, and humidity conditions.

9. The scheduling system of claim 1, wherein the touch screen based user interface is adapted to display alert messages in case of a fault in the device.

10. The scheduling system of claim 1, wherein the communication network is adapted to facilitate communication of different settings, modes of operation of the device corresponding to different time zones in accordance with the particular operation schedule set by the user to a thermostat of a control system of the device.

11. The scheduling system of claim 1, wherein:
the touch screen based user interface is a touch screen of a mobile phone, a Tablet device, or a remote control for remotely controlling the device; and
the touch screen based user interface is adapted to display additional selectable options on a second screen when selected by the user.

12. A scheduling system for scheduling operation of a heating, ventilation, and air conditioning (HVAC) system, the scheduling system comprising:
a touch screen based user interface adapted to display on a single screen a plurality of scrollable, selectable options corresponding to different settings, different modes of operation of the HVAC system to be scheduled, and different time zones for which the HVAC system is to be scheduled, the touch screen based user interface further adapted to display the different settings and the different modes of operation of the HVAC system for the different time zones as selected by a user to define a particular operation schedule for the HVAC system;
a selection module adapted to facilitate navigation and selection of the options from the plurality of scrollable, selectable options displayed on the touch screen based user interface for selectively defining a particular operation schedule for the HVAC system;
a storage memory adapted to store data corresponding to different settings, different modes of operation of the HVAC system to be scheduled and different time zones for which the HVAC system is to be scheduled; and
a communication network adapted to facilitate communication of different settings, modes of operation of the HVAC system corresponding to different time zones in accordance with a particular operation schedule set by the user to a thermostat of a control system of the HVAC system.

13. The scheduling system of claim 12, wherein:
the touch screen based user interface is a touch screen of a mobile phone, a Tablet device, or a remote control for remotely controlling the device; and
the touch screen based user interface is adapted to display additional selectable options on a second screen when selected by the user.

14. A method of scheduling operation of a device, the method comprising:
displaying on a single screen of a touch screen based user interface a plurality of scrollable, selectable options corresponding to different settings, different modes of operation of the device to be scheduled, and different time zones for which the device is to be scheduled;
displaying the different settings and the different modes of operation of the device for the different time zones as selected by a user to define a particular operation schedule for the device;
facilitating navigation and selection of the options from the plurality of scrollable, selectable options displayed on the touch screen based user interface for selectively defining a particular operation schedule for the device;
storing data corresponding to different settings, different modes of operation of the device to be scheduled and different time zones for which the device is to be scheduled; and
communicating, across a communication network, different settings, modes of operation of the device corresponding to different time zones in accordance with a particular operation schedule to the device for controlling the device as per a defined operation schedule set by the user for the device.

15. The method of claim 14, wherein the plurality of scrollable, selectable options displayed on the touch screen based user interface are navigated and selected by the user's touch.

16. The method of claim 14, wherein:
displaying comprises displaying on a touch screen of a mobile phone, a Tablet device, or a remote control for remotely controlling the device; and
displaying comprises displaying additional selectable options on a second screen of the touch screen when selected by the user.

17. The method of claim 14, wherein:
the device is a heating, ventilation, and air conditioning (HVAC) system; and
communicating comprises communicating to a thermostat of a control system of the HVAC system the different settings, modes of operation of the HVAC system corresponding to different time zones in accordance with a particular operation schedule set by the user.

18. The method of claim 14, comprising:
navigating through different temperature settings and selecting a temperature setting for achieving temperature control corresponding to a particular operation schedule defined by the user of the device; and/or
navigating through different humidity settings and selecting a humidity setting for achieving humidity control corresponding to a particular operation schedule defined by the user of the device.

19. The method of claim 14, further comprising displaying on the touch screen based user interface a save option for facilitating saving of the settings and modes of operation of the device corresponding to a particular operation schedule set by the user for future use.

20. The method of claim 14, further comprising displaying on the touch screen based user interface an alert message in case of a fault in the device.
